(19) United States
(12) Patent Application Publication
(10) Pub. No.: US 2006/0285327 A1
(43) Pub. Date: Dec. 21, 2006

(54) Bedding cover and associated methods

(75) Inventors: Jeffrey J. Abraham, Orlando, FL (US); Gregg T. Dobbs, Windermere, FL (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: BEDBUG LIGHTS, INC., Orlando, FL (US)

(21) Appl. No.: 11/466,823

(22) Filed: Aug. 24, 2006

Related U.S. Application Data
(62) Division of application No. 10/987,913, filed on Nov. 12, 2004, now abandoned.
(60) Provisional application No. 60/519,839, filed on Nov. 13, 2003.

(51) Int. Cl. F21V 33/00

(52) U.S. Cl. 362/253; 362/458

(57) ABSTRACT

A bed covering has a translucent top layer that has a pattern thereon with a plurality of decorative elements that are positioned in a plurality of sectors. An array of light-emitting elements is positioned beneath the top layer. The array is segregated into sectors corresponding to at least some of the top-layer sectors. A control element is programmable to activate the light-emitting elements within the sectors in a predetermined pattern. Such an activation backlights the decorative elements in the top-layer sectors in the predetermined pattern. Additional elements of the bed covering may include an audio emitter for providing sound commensurate with the predetermined pattern and a light-diffusing element positioned between the top layer and the light-emitting-element array for providing a more diffuse illumination of the sectors. The top layer is interchangeable with another top layer having corresponding sectors to permit the illumination of the corresponding sectors in the predetermined pattern.

### CROSS-REFERENCE TO RELATED APPLICATIONS

This application is a divisional of application Ser. No. 10/987,913, filed Nov. 12, 2004, entitled “Bedding Cover and Associated Methods,” which itself claimed priority to provisional application Ser. No. 60/519,839, filed Nov. 13, 2004, entitled “Programmable Audio/visual Tapestry Display and Method.”

### FIELD OF THE INVENTION

The present invention generally relates to bedding and, in particular, to decorative and interactive bedding and methods for using and making same.

### BACKGROUND

Decorative bedding is known wherein scenes are imprinted thereon. For example, for children, cartoon characters or action figures may be represented. It is also known to incorporate light and sound elements into bedding, the light elements positioned atop the bedding to represent features such as eyes of a creature. It is further known to affix a light-emitting phosphorescent material to bedding to display a pattern in the dark for a period of time following illumination.

It would be desirable to provide bedding that is decorative, amusing, and comforting, and includes entertainment elements, the bedding being activatable and stimulating to the imagination of the user. It would also be desirable to provide such bedding portions of which are exchangeable with other bedding portions for introducing different entertainment elements.

### SUMMARY OF THE INVENTION

The present invention is directed to a bed covering that comprises a translucent top layer that has a pattern thereon. The pattern comprises a plurality of decorative elements that are positioned in a plurality of sectors. An array of light-emitting elements is positioned beneath the top layer. The array is segregated into sectors corresponding to at least some of the top-layer sectors.

A control element is in signal communication with the light-emitting elements, and is programmable to activate at least some of the light-emitting elements within at least some of the sectors in a predetermined pattern. Such an activation backlights at least some of the decorative elements in the top-layer sectors in the predetermined pattern.

Additional elements of the bed covering may include an audio emitter for providing sound commensurate with the predetermined pattern and a light-diffusing element positioned between the top layer and the light-emitting-element array for providing a more diffuse illumination of the top layer sectors.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWING

FIG. 1 is a side cross-sectional schematic illustration of the bed covering layers of the present invention.

FIGS. 2A-2P represent alternate embodiments of LED holders and positions.

FIG. 3 is a top plan view of the light-emitting-element array.

FIG. 4 is a side-cross-sectional view of the light-emitting-element array.

FIG. 5 is a top-side view of an exemplary switch.

FIG. 6 is a top plan view of the light-diffusing layer positioned atop the light-emitting-element array.

FIG. 7 is a side cross-sectional view of the light-diffusing layer positioned atop the light-emitting-element array.

FIG. 8 illustrates the means for affixing the light-diffusing layer to the light-emitting-element array.

FIG. 9 is a top plan view of an alternate embodiment of a light-diffusing layer positioned atop the light-emitting-element array.

FIG. 10 is a detailed view of a diffusing element of FIG. 9.

FIG. 11A and 11B are alternate embodiments of a battery case.

FIG. 12 is an exploded view of a battery case affixed to the fabric of the light-emitting-element array.

FIG. 13 illustrates a pouch for the battery case.

FIG. 14 illustrates an exploded view of a top layer atop a light-emitting-element array.

FIGS. 15A-15E illustrate an exemplary story mode sequence.

FIGS. 16A-16E illustrate an exemplary sleep mode sequence.

### DETAILED DESCRIPTION OF THE PREFERRED EMBODIMENT

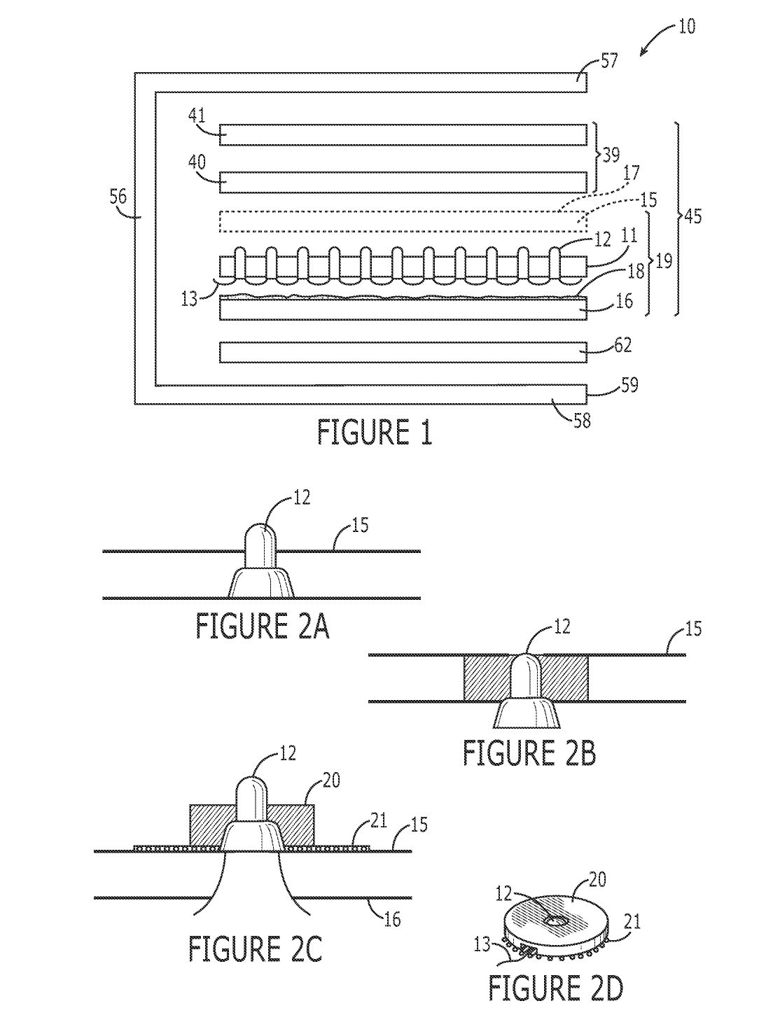

A description of the preferred embodiments of the present invention will now be presented with reference to FIGS. 1-16E .

The present invention in a particular embodiment is directed to a bed covering; however, one of skill in the art will recognize that the structure and method of operation of the invention could be applied to other embodiments as well, and no limitation is intended by the use of the descriptor “bed covering.”

In this embodiment, the bed covering 10 comprises a plurality of layers, as shown in FIG. 1. One layer comprises an array 11 of light-emitting elements, for example, light-emitting diodes (LEDs) 12, in circuit connection 13 with a power source and control element to be described in the following. Preferably each of the LEDs 12 is positioned in a protective holder 14, which is in lateral surrounding relation thereto.

In a preferred embodiment, an upper 15 and a lower 16 protective sheet are positioned in surrounding relation to the light-emitting-element array. The upper protective sheet 15 preferably has an aperture 17 therethrough above each of the light-emitting elements. Also preferably, the upper 15 and the lower 16 protective sheets are translucent and substantially water-impervious, and may comprise, for example, nylon, particularly rip stop nylon, although this is not intended as a limitation. The upper 15 and lower 16 protective sheets are preferably cleanable by wiping down, for example. In the embodiment shown in FIG. 1, the upper 15 and the lower 16 protective sheets are joined together with an adhesive 18 to form a unitary light-emitting layer 19. The light-emitting layer 19, owing to its construction, is flexible and can be rolled up without damaging the elements.

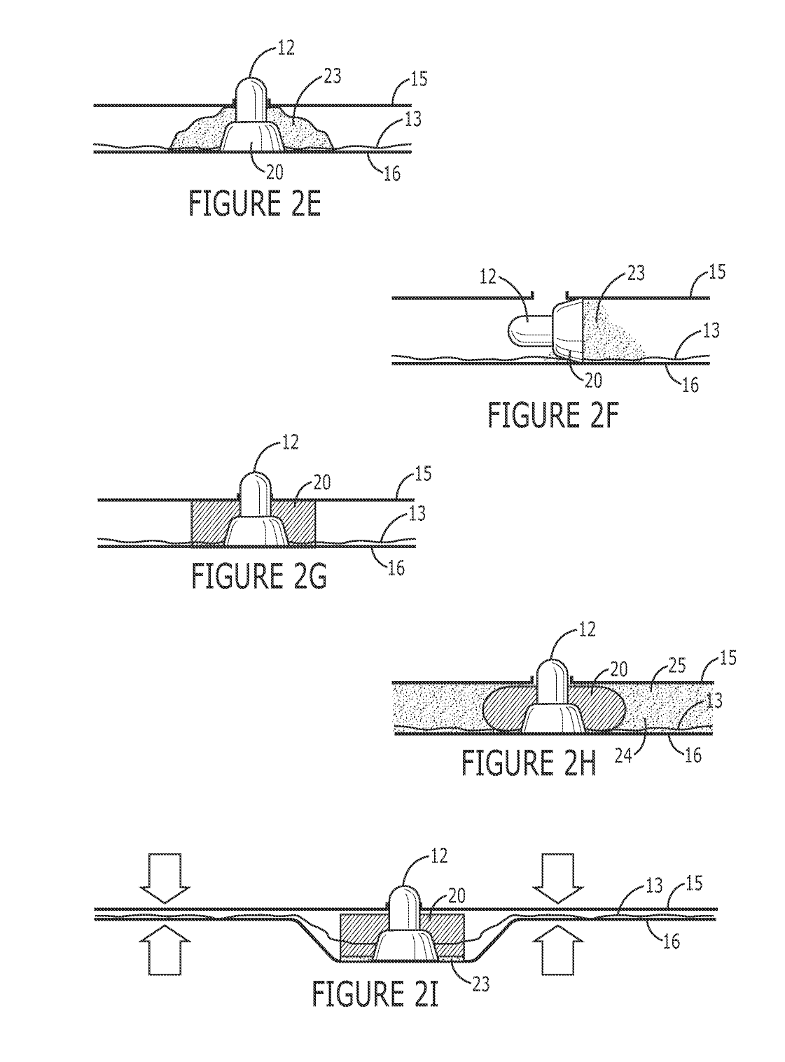

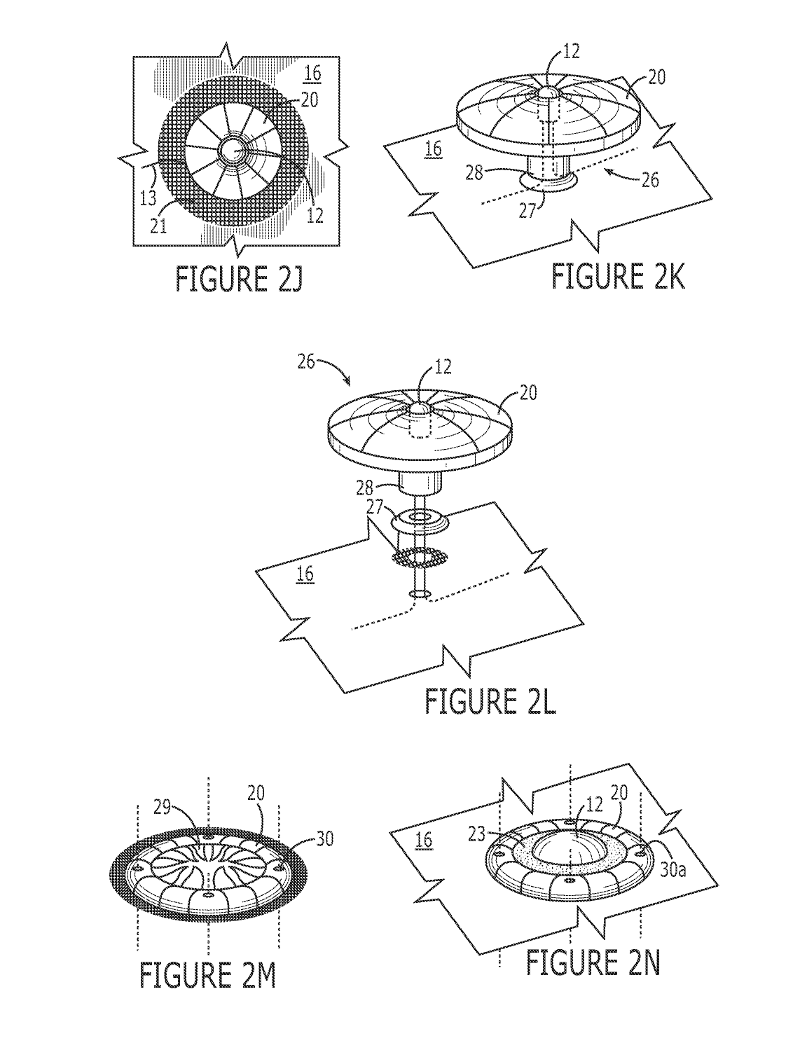

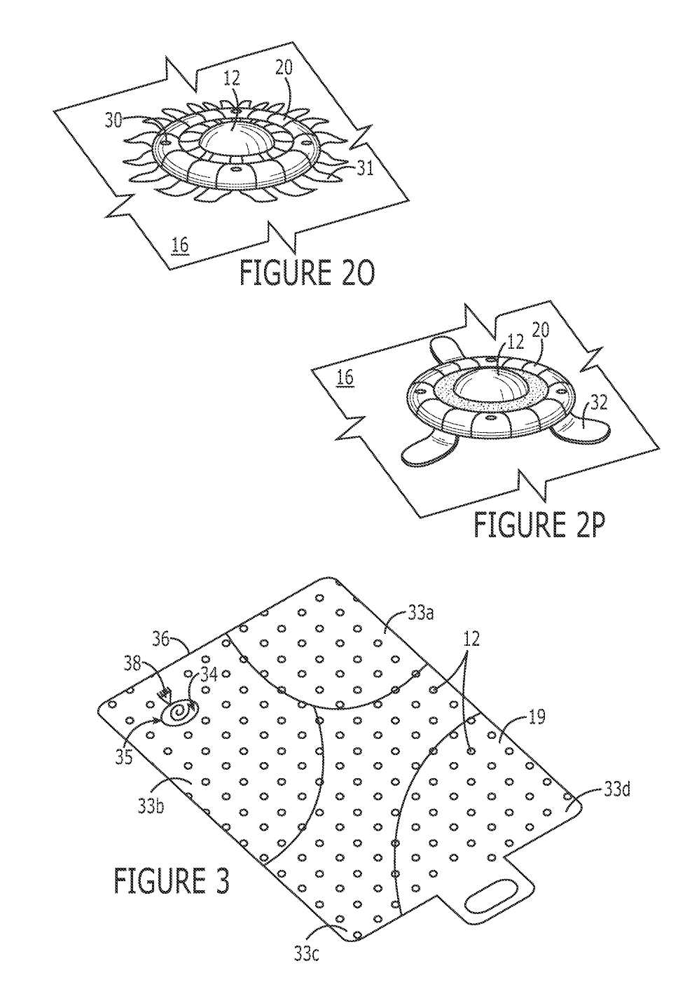

A plurality of embodiments of the holder 14 may be envisioned, as illustrated in FIGS. 2A-2P. In FIG. 2A, the LED 12 protrudes above the upper sheet 15; in FIG. 2B, the top of the LED 12 is below the upper sheet 15; in FIG. 2C, the LED 12 is encased in a toroidal holder 20, such as rubber (FIG. 2D), and is surrounded by a mesh layer 21. FIG. 2E illustrates the joining of the upper 15 and lower 16 sheets, and the LED holder 20 kept in place with glue 23. In FIG. 2F the LED 12 is positioned on its side, with the holder 20 again kept in place with glue 23. A soft ring 20 is also used in the embodiments of FIGS. 2G-I. In FIG. 2H a space 24 between the upper 15 and the lower 16 sheets is filled with soft beads 25. In FIG. 21, adhesive 23 is applied and the upper 15 and the lower 16 sheets are vacuum-sealed together.

In the embodiments of FIGS. 2J-2P, all the LEDs 12 are surrounded by toroidal rubber holders 20, and various methods of affixing the holders 20 to the lower sheet 16 are illustrated. In FIG. 2J, a mesh 21 surrounds the holder 20, which is glued to the lower sheet 16; in FIGS. 2K and 2L, a toadstool-shaped element 26 is affixed to the lower sheet 16, with a ring 27 surrounding the lower end 28 of the holder 20. The embodiment of FIGS. 2M and 2N has a plurality of finger-like structures 29 extending inwardly toward the center of the ring 20, and holes 30 are provided for use in affixing to the lower sheet 16 using, for example, rubber buttons sewn through the fabric, as well as an adhesive 23 such as, for example, epoxy. The embodiments of FIGS. 20 and 2P have outwardly extending petal-like structures 31 and “feet” 32 that can be glued 23 over to the lower sheet 16.

In all embodiments, the LEDs 12 are segregated into sectors 33a-33d (FIG. 3), which are under control of a programmable control element 34 that is in signal communication with the LEDs 12. The control element 34 is programmable to activate at least some of the LEDs 12 within at least some of the sectors 33a-33d in a predetermined pattern, which will be described further in the following.

The control element 34 is under control of an on/off switch 35 (FIG. 5), which preferably is located adjacent a top edge 36 of the light-emitting layer 19, for ease of reach by the user. Preferably the switch 35 comprises a soft, raised element, for example, in the shape of a coil 37, to facilitate the user's locating it in the dark.

The bed covering 10 further comprises, in signal communication with the control element 34, an audio emitter 38. The control element 34 is further programmable to activate the audio emitter 38 to emit sounds in a predetermined pattern, as will be described in the following. Preferably the audio emitter 38 is positioned adjacent the switch 35.

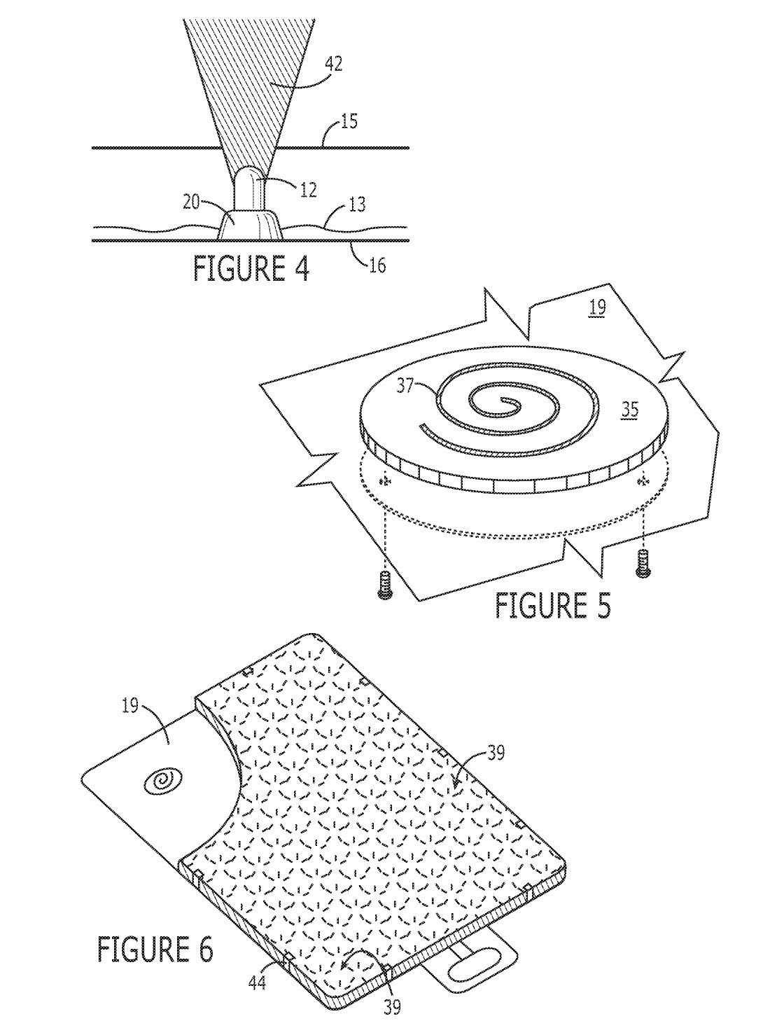

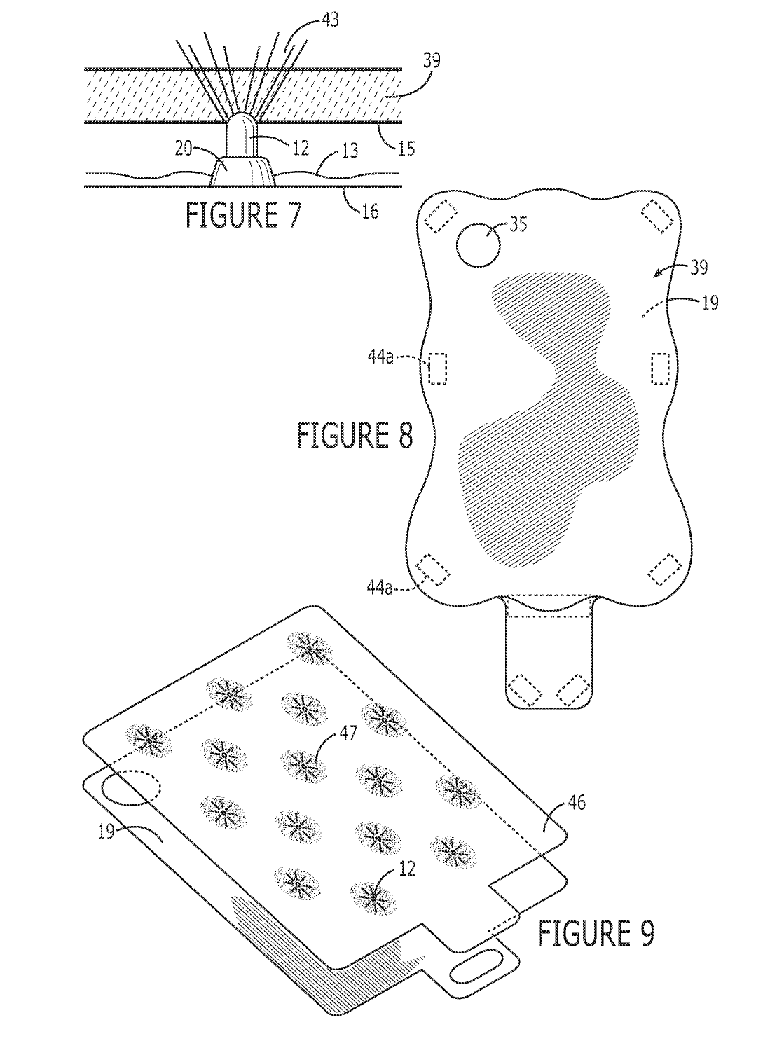

The bed covering 10 further comprises a light-diffusing layer 39 that is positioned above the light-emitting layer 19 (FIGS. 1 and 6). In a particular embodiment, the light-diffusing layer 39 comprises a batting material 40 atop the LEDs 12, and a mesh material 41 positioned above the batting material 40. The effect of the light-diffusing layer 39 is illustrated schematically in FIGS. 4 and 7, wherein it can be seen that LED light emerging from the light-emitting layer 19 shines in a narrow cone 42, but that light 43 emerging from the light-diffusing layer 39 is spread outward virtually isotropically, including downward. The light-diffusing layer 39 is affixed to the light-emitting layer 19 via, for example, tabs 44, to form an illumination unit 45. Alternatively, Velcro-type fasteners may be used (FIG. 8).

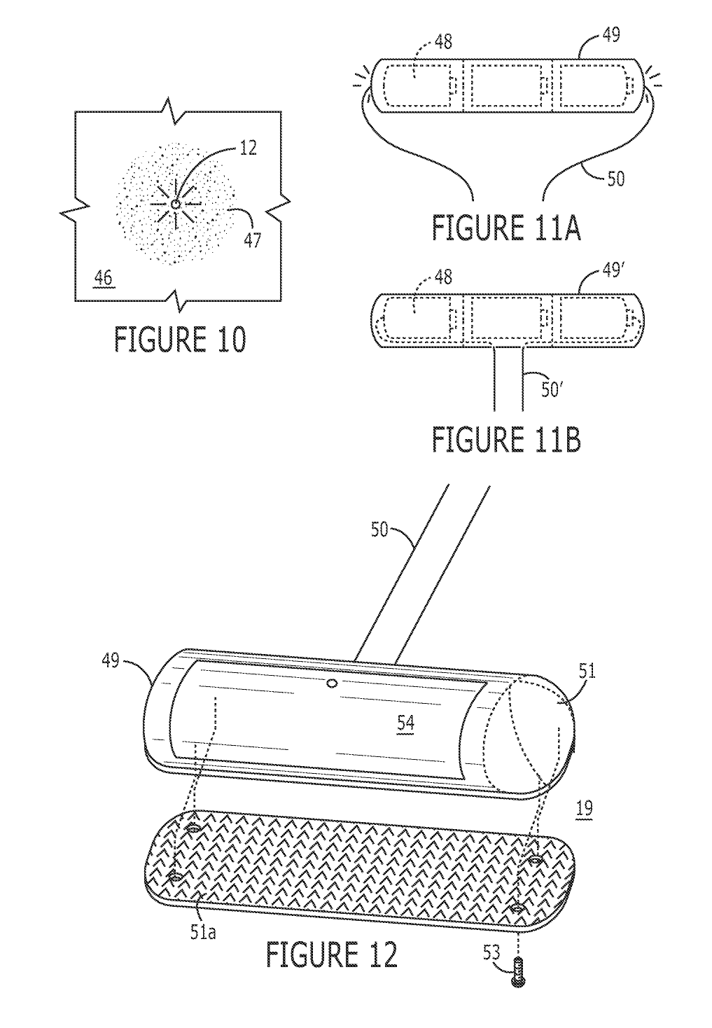

An alternate embodiment of the light-diffusing layer 46 is illustrated in FIGS. 9 and 10, wherein additional shiny elements 47 are added, such as, but not intended to be limited to, sparkling, glimmering, or shimmering elements such as glitter, to add to the effect of the LEDs 12.

Power for the LEDs 12 and control element 34 is provided by batteries, such as D batteries 48, housed in a battery receptacle 49 (FIGS. 11A-13). FIGS. 11A and 11B are alternate embodiments of the battery receptacle 49,49′, wherein the connecting wires 50,50′ are shown emerging from ends of the receptacle 49 and from a more central location of the receptacle 49′. The latter is believed to represent a preferred embodiment.

The battery receptacle 49 (FIG. 12) comprises, for example, a substantially cylindrical base 51 affixed to a mounting plate 51a that is in turn affixed to a protrusion 52 from the light-emitting layer 19 by fasteners such as screws 53 or using glue. A removable door 54 admits the user into the base 51 for changing the batteries 48. The mounting plate 51a may have, for example, ridges in the surface facing the fabric for improving friction therebetween. The rounded edges of the base 51 are believed preferable for safety, thereby avoiding sharp edges or corners.

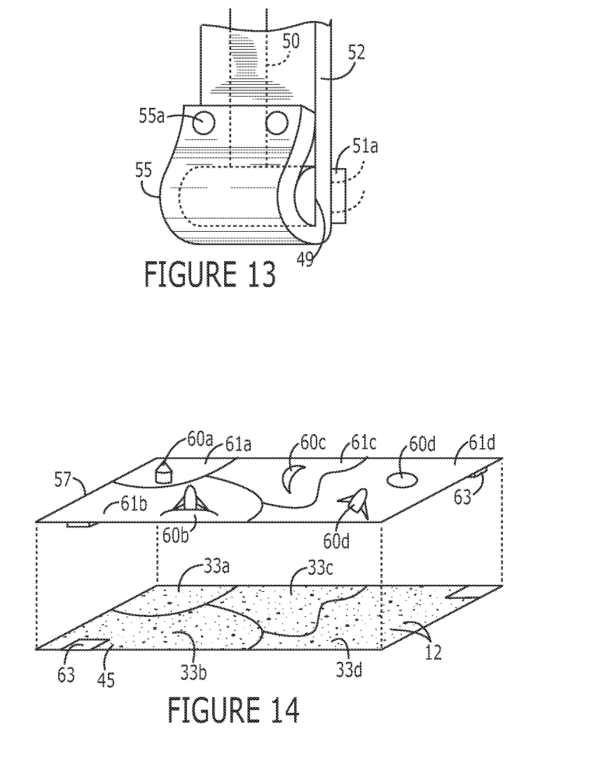

The battery receptacle 49 is shielded by a pouch 55 (FIG. 13) that can be, for example, formed by snapping or buttoning 55a the protrusion 52 over the receptacle 49. This permits the receptacle 49 to depend downward from the bottom of the bed to protect it from the user's movements and not to cause discomfort to the user.

Surrounding the illumination unit 45 is a pocket 56 formed by a translucent top layer 57 and a preferably translucent bottom layer 58, stitched together along three sides, the unstitched edge 59 providing an opening for admitting the illumination unit 45 (FIG. 1).

The top layer 57 has a pattern thereon that comprises a plurality of decorative elements 60a-60d that are positioned in a plurality of sectors 61a-61d (FIG. 14). At least some of the top-layer sectors 61a-61d correspond to the LED sectors 33a-33d. When the LEDs in each of the sectors 33a-33d are illuminated, they backlight at least some of the decorative elements 60a-60d in the top-layer sectors 61a-61d in the predetermined pattern as programmed in the control element 34. It has been found that a preferred fabric for the top layer 57 comprises a material having a high polyester content, such as 65%, in order to optimize the glowing effect caused by the illumination unit 45. In addition, the LEDs 12 also permit a diffuse light to shine downward through the bottom layer 58, providing a dimly lighted space under the bed covering 10, akin to a flashlight under the covers, which is attractive to children.

Another benefit of the bed covering 10 of the present invention is that the pocket 56 is removable for washing, and can also be interchanged with other pockets having substantially the same physical distribution of sectors 61a-61d, but with different decorative elements.

Also provided are means for retaining the illumination unit 45 in substantial registry with the top layer 57, for retaining the top layer sectors 61a-61d in substantial alignment with the light-emitting-element array sectors 33a-33d. For example, a plurality of detachable fixation elements such as Velcro fasteners 63 may be affixed to the illumination unit 45 and the top layer 57.

The bed covering 10 may also include, or be dimensioned for holding, a comforter 62, positionable within the pocket 56 beneath the illumination unit 45 (FIG. 1).

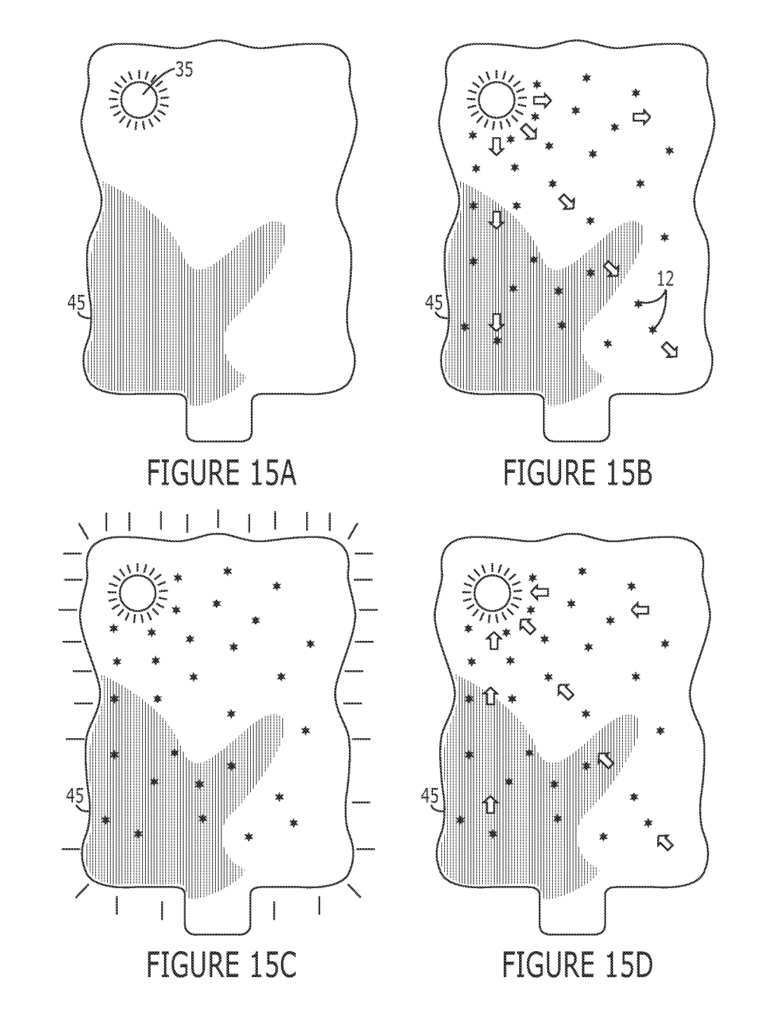

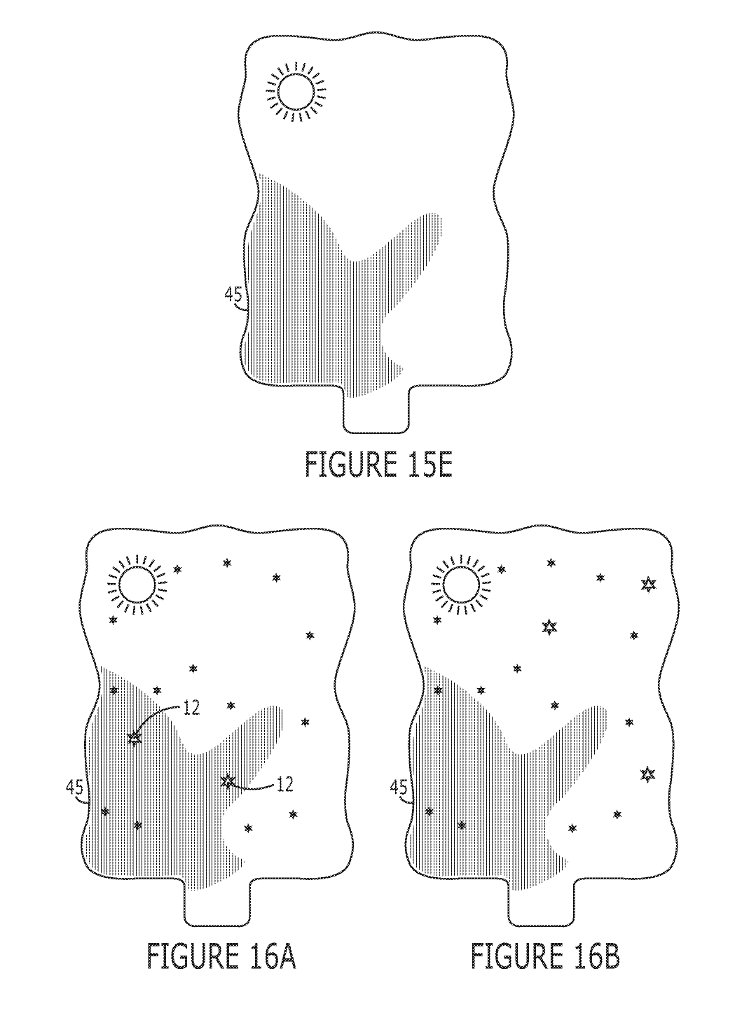

In use, the bed covering 10 can provide entertainment and a decorative experience akin to a light and sound show to the user. As illustrated in FIGS. 15A-15E, a series of illumination patterns can be effected by the programmable control element 34, wherein, when the switch 35 is activated (FIG. 15A), LEDs 12 are illuminated in an outward sequence (FIG. 15B) to reach different sectors 33a-33d at different times. At some point in the sequence, a maximum number of LEDs 12 may be illuminated (FIG. 15C). The sequence may then include a reversal of the illumination pattern (FIG. 15D) until the covering is unilluminated (FIG. 15E).

The show sequence illustrated in FIGS. 15A-15E can be used to entertain and stimulate the imagination of a child, for example, by asking the child to make up a story commensurate with the light sequence. For example, a spaceship may be illuminated prior to takeoff, during takeoff, and in space. Alternatively, a superhero character can be illustrated performing heroic acts in sequence.

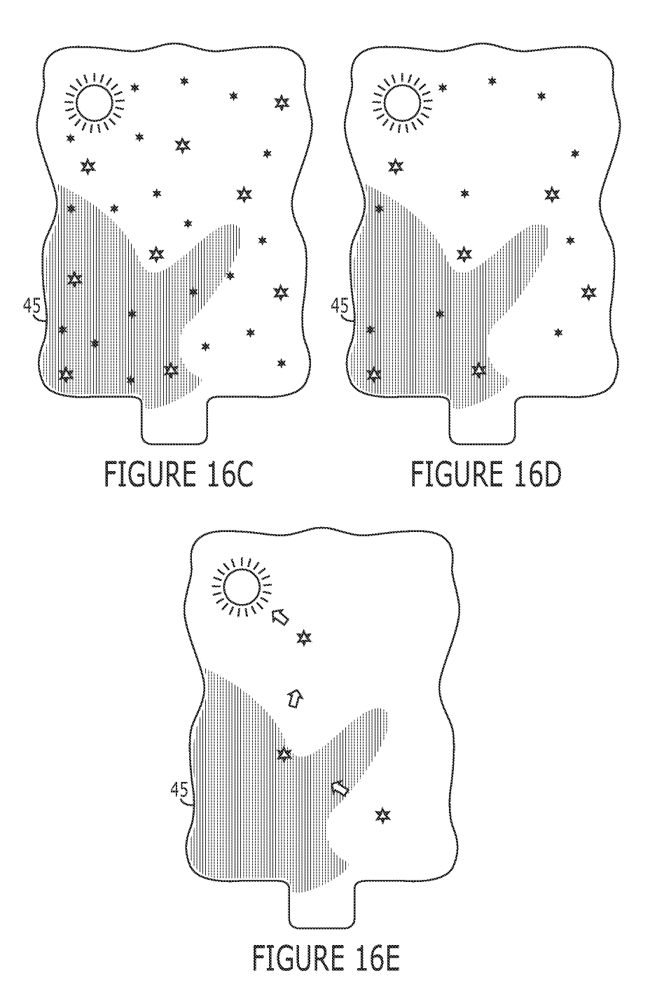

In another sequence, which may be initiated following the show sequence, comprises a more muted “sleep sequence” (FIGS. 16A-16E). In this exemplary sequence, only a few LEDs 12 are illuminated, for example, in a pseudorandom pattern that gradually fades until no LEDs 12 are illuminated.

The timing of the sequences is obviously a matter of design choice, and the programmable nature of the control unit 34 permits virtually limitless options in the sequences provided. That outlined above is believed to represent a preferred embodiment for a child prior to failing asleep.

Another benefit of the bed covering 10 is that it can provide security to a fearful child, since the switch 35 can be activated during the night if the child awakens and is afraid.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the apparatus illustrated and described herein are by way of example, and the scope of the invention is not limited to the exact details of construction.

Having now described the invention, the construction, the operation and use of preferred embodiments thereof, and the advantageous new and useful results obtained thereby, the new and useful constructions, and reasonable mechanical equivalents thereof obvious to those skilled in the art, are set forth in the appended claims.

What is claimed is:

1. A bed covering comprising:
a translucent top layer having a pattern thereon comprising a plurality of decorative elements positioned in a plurality of sectors, the top layer comprising a first and a second top layer having different patterns comprising a plurality of different decorative elements thereon, the decorative elements for each of the first and the second top layer positioned in a same plurality of sectors;
an array of light-emitting elements positioned beneath one of the first and the second top layer, the array segregated into sectors corresponding to at least some of the top-layer sectors, the first and the second top layer thereby interchangeable for use with the light-emitting-element array;
a light-diffusing layer positioned between the one of the first and the second top layer and the light-emitting-element array; and
a control element in signal communication with the light-emitting elements, the control element programmable to activate at least some of the light-emitting elements within at least some of the sectors in a predetermined pattern, thereby backlighting at least some of the decorative elements in the top-layer sectors in the predetermined pattern.

2. The bed covering recited in claim 1, wherein the light-diffusing layer comprises a batting material.

3. The bed covering recited in claim 2, wherein the light-diffusing layer further comprises a mesh material positioned between the batting material and the one of the first and the second top layer.

4. The bed covering recited in claim 1, wherein the light-emitting-element array comprises an array of light-emitting diodes and circuitry connecting each diode with the control element.

5. The bed covering recited in claim 1, further comprising an upper and a lower protective sheet positioned in surrounding relation to the light-emitting-element array, the upper protective sheet having an aperture therethrough above each of the light-emitting elements.

6. The bed covering recited in claim 5, wherein the upper and the lower protective sheet are substantially water-impervious and are joined together with an adhesive to form a unitary light-emitting layer.

7. The bed covering recited in claim 6, further comprising a plurality of detachable fixation elements affixed to the light-emitting layer and the one of the first and the second top layer, for retaining the light-emitting layer in substantial registry with the one of the first and the second top layer, for retaining the top layer sectors in substantial alignment with the light-emitting-element array sectors.

8. The bed covering recited in claim 1, further comprising a translucent bottom layer positioned beneath the light-emitting-element array, the light-emitting elements adapted to illuminate upwardly and downwardly.

9. The bed covering recited in claim 1, further comprising an audio emitter in signal communication with the control element, the control element further programmable to activate the audio emitter to emit sounds commensurate with the predetermined pattern.

10. The bed covering recited in claim 1, wherein the control element is further programmable to, following an execution of the predetermined pattern, gradually decrease a number of light-emitting elements that are illuminated until none is illuminated.

11. The bed covering recited in claim 1, further comprising a battery receptacle positioned along a bottom edge of the bed covering and positioned to depend from the bottom edge of the bed, the battery receptacle in signal communication with the control element.

12. The bed covering recited in claim 1, further comprising a switch in signal communication with and for activating and deactivating the control element, the switch positioned adjacent a top edge of the bed covering and comprising a soft element raised above a level of the one of the first and the second top layer.

13. A method of making a bed covering, comprising the steps of:
positioning an array of light-emitting elements beneath a translucent first top layer having a pattern thereon comprising a plurality of decorative elements positioned in a plurality of sectors, the array segregated into sectors corresponding to at least some of the first-top-layer sectors;
positioning a light-diffusing layer between the first top layer and the light-emitting-element array;
placing a control element in signal communication with the light-emitting elements;
programming the control element to activate at least some of the light-emitting elements within at least some of the sectors in a predetermined pattern, thereby backlighting at least some of the decorative elements in the first-top-layer sectors in the predetermined pattern; and
interchanging a second top layer for the first top layer, the second top layer having a second pattern different from the first-top-layer pattern, the second pattern comprising a plurality of decorative elements thereon, the decorative elements for the second top layer positioned in the same plurality of sectors as those of the first top layer, the first and the second top layer thereby interchangeable for use with the light-emitting-element array.

14. The method recited in claim 13, wherein the light-diffusing layer comprises a batting material.

15. The method recited in claim 13, further comprising the step of positioning an upper and a lower protective sheet in surrounding relation to the light-emitting-element array, the upper protective sheet having an aperture therethrough above each of the light-emitting elements.

16. The method recited in claim 15, further comprising the step of joining together the upper and the lower protective sheets with an adhesive to form a unitary light-emitting layer, the upper and the lower protective sheets substantially water-impervious.

17. The method recited in claim 13, further comprising the steps of affixing three outer edges of a bottom layer to a corresponding three outer edges of the first top layer to form a pocket, and positioning the pocket in encompassing relation to the light-emitting-element array.

18. The method recited in claim 17, further comprising the step of positioning a comforter within the pocket beneath the light-emitting-element array.

19. The method recited in claim 13, further comprising the step of positioning a translucent bottom layer beneath the light-emitting-element array, the light-emitting elements adapted to illuminate upwardly and downwardly.

20. The method recited in claim 21, further comprising the steps of positioning a battery receptacle along a bottom edge of the bed covering so as to depend from the bottom edge of the bed, and placing the battery receptacle in signal communication with the control element.

21. The method recited in claim 13, further comprising the steps of placing a switch in signal communication with the control element, the switch adapted to activate and deactivate the control element and comprising a soft element raised above a level of the first top layer, and positioning the switch adjacent a top edge of the bed covering.
